(19) United States
(12) Patent Application Publication
(10) Pub. No.: US 2008/0122577 A1
(43) Pub. Date: May 29, 2008

(54) System and Method for Selectively Activating Biometric Sensors

(76) Inventors: Srinivas Gutta, Veldhoven (NL); Vasanth Philomin, Stolberg (DE); Miroslav Trajkovic, New York, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/556,247

(22) PCT Filed: May 6, 2004
(86) PCT No.: PCT/IB04/01500

§ 371 Date: Nov. 10, 2005

Related U.S. Application Data
(60) Provisional application No. 60/469,675, filed on May 12, 2003.

(51) Int. Cl. G06F 7/04

(52) U.S. Cl. 340/5.52

(57) ABSTRACT

A system and method is provided for selectively activating biometric sensors (102, 104, 106) to authenticate the identity of an individual while conserving system resources. A biometric system has at least two tiers of sensors, first (102) and second tier sensors (104, 106), where the first tier sensors (102) are characteristically less sophisticated and less expensive to operate than the second tier sensors (104, 106). One or more of the second tier sensors (104, 106) are activated only after a user's biometric is successfully or unsuccessfully verified by one of the first tier sensors (102). Alternatively, the second tier sensors (104, 106) are activated in response to a user requesting a particular level of service or in response to an environmental condition. Alternatively, only those sensors are turned on which are compatible with a user's biometric profile.

The present invention relates generally to security, and in particular, to a system and method for selectively activating biometric sensors to provide such security while simultaneously conserving system resources.

The field of biometrics, or the measuring of a physical characteristic used to recognize the identity or verify the claimed identity of an individual, has emerged as an increasingly reliable methodology for verification (one-to-one) and identification (one-to-many) of individuals. Biometrics has become a very powerful tool in the solving of problems associated with requiring positive identification of individuals.

Live capture biometrics, which is the process of capturing a biometric sample by an interaction between an end user and a biometric system, requires a significant amount of memory, processing power and communication capabilities to quickly and accurately perform the biometric functions assigned. As one example, it is most often the case that, for access to certain restricted areas, multiple biometric sensors are often used to authenticate the identity of an individual. The multiple biometric sensors may include, for example, face, fingerprint and iris recognition whereby an individual must be authenticated by each sensor before access is performed.

Presently, systems that are equipped with such multiple sensors have them switched on all the time. The primary disadvantage is that valuable resources are tied up as the system constantly scans the sensor for the presence of data.

Therefore, it would be desirable to selectively activate the sensors such that the system resources could be conserved.

The present invention is directed to a system and method for selectively activating one or more biometric sensors to authenticate the identity of an individual while conserving system resources. System resource conservation could be embodied in any number of ways including, for example, the conservation of battery power when using biometric sensors on a mobile device, conserving processor usage and conserving network bandwidth if biometric authentication data is required to be transmitted across a network to one or more remote locations.

A biometric system, in accordance with the invention, is comprised of at least two tiers of sensors, first tier and second tier sensors, where the first tier sensors are characteristically less sophisticated and less expensive to operate than the second tier sensors.

In accordance with a first embodiment, one or more of the second tier sensors are activated (i.e., turned “on”) only after a user's biometric is successfully verified by a first tier sensor.

In accordance with a second embodiment, one or more of the second tier sensors are activated (i.e., turned “on”) only after a user's biometric is unsuccessfully verified by the first tier sensor.

In accordance with a third embodiment, one or more of the second tier sensors are activated (i.e., turned “on”) in response to a user requesting a particular level of service. For example, in the context of an ATM transaction (service), one or more of the second tier sensors are activated when a transaction request exceeds one millions dollars (the level of service).

In accordance with a fourth embodiment, one or more of the second tier sensors are activated (i.e., turned “on”) in response to an environmental condition. For example, a face sensor could be activated when the illumination level in a room exceeds a certain pre-defined threshold illumination level. As a further example, in response to a determination act to determine that the air quality is too humid or too dry, biometric verification of a user could be performed by a second tier sensor instead of using the first tier sensor, e.g., the fingerprint sensor.

In accordance with a fifth embodiment, only those sensors are turned on which are compatible with a user's biometric profile. In the present embodiment, a user enrolls with the system during an enrollment phase. During this phase, the biometric system determines which of the sensors are compatible with the user for obtaining his or her biometric. Later, during system operation, a user presents his or her identification to the system which retrieves the user's biometric profile and only activates those sensors which were determined to yield a favorable result during enrollment.

Detailed description of preferred embodiments of the invention will be made with reference to the accompanying drawings:

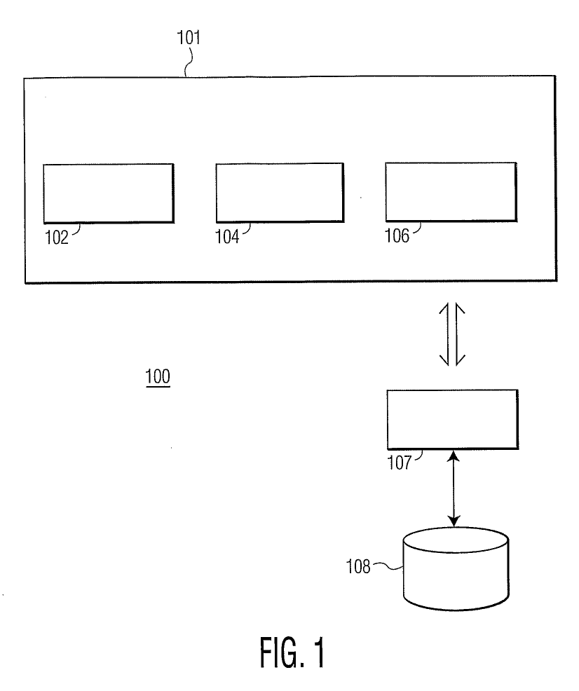

FIG. 1 is a diagram illustrating an illustrative biometric detection system in which the methods of the invention may be practiced;

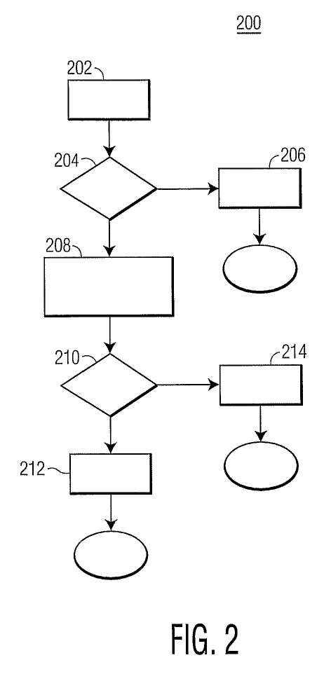

FIG. 2 is a flowchart for illustrating a first exemplary method for selectively activating biometric sensors to conserve system resources while performing biometric identification procedures, in accordance with a first embodiment of the invention;

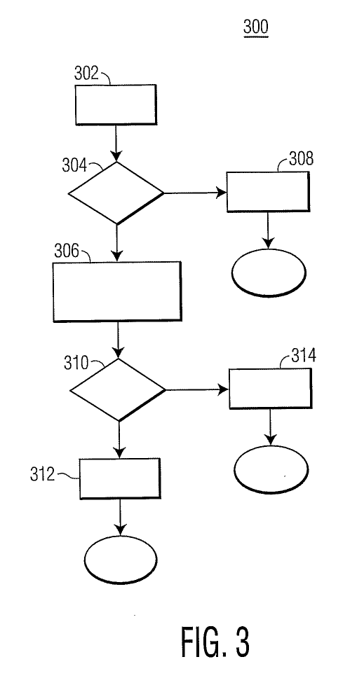

FIG. 3 is a flowchart for illustrating a second exemplary method for selectively activating biometric sensors to conserve system resources while performing biometric identification procedures, in accordance with another embodiment of the invention;

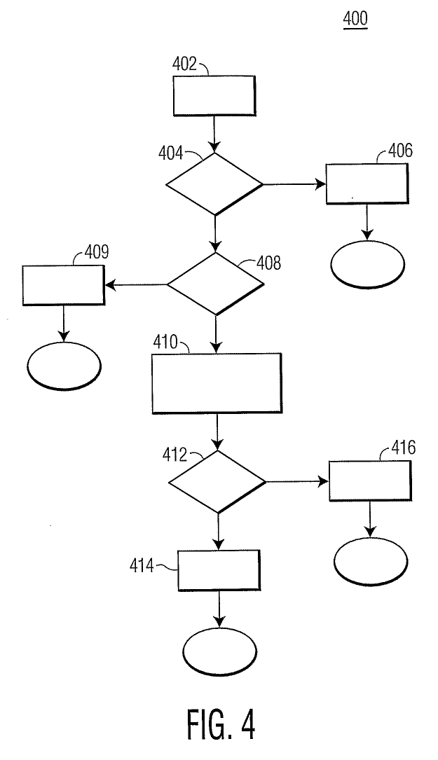

FIG. 4 is a flowchart for illustrating a third exemplary method for selectively activating biometric sensors to conserve system resources while performing biometric identification procedures, in accordance with a further embodiment of the invention;

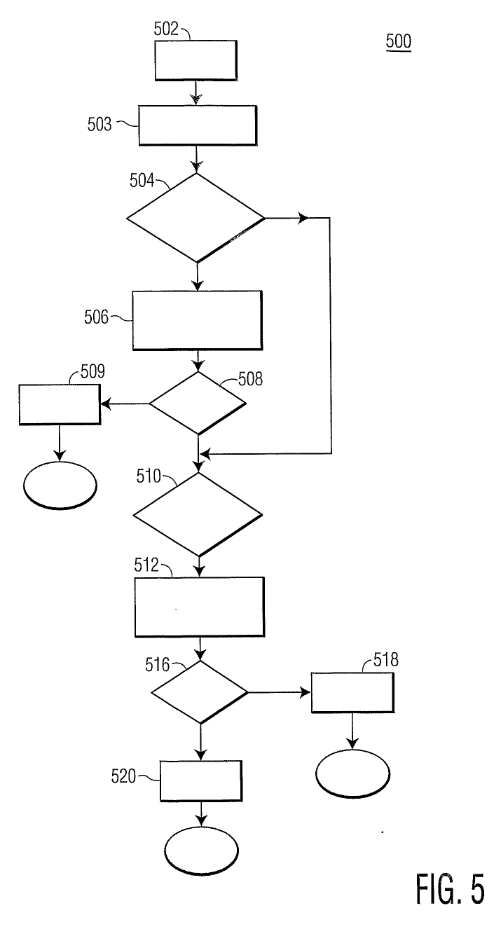

FIG. 5 is a flowchart for illustrating a fourth exemplary method for selectively activating biometric sensors to conserve system resources while performing biometric identification procedures, in accordance with a still further embodiment of the invention; and

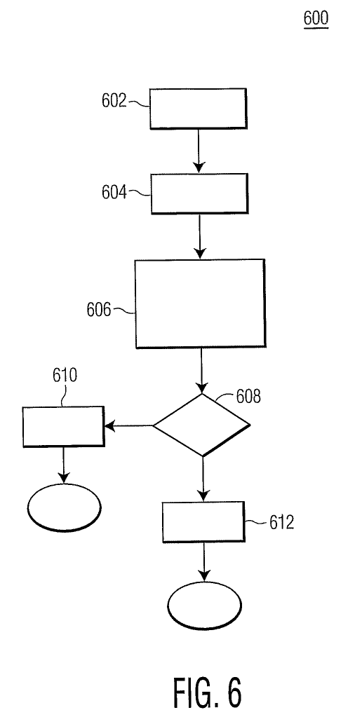

FIG. 6 is a flowchart for illustrating a fifth exemplary method for selectively activating biometric sensors to conserve system resources while performing biometric identification procedures, in accordance with yet another embodiment of the invention.

The present invention relates generally to a biometric recognition system and associated methods for selectively activating biometric sensors so as to conserve system resources while performing biometric identification procedures. The systems and methods of the invention has applicability for operation in situations requiring biometric identification procedures including, for example, ingress and egress to a physical plant or real property, access to services as well as resources such as computer data, bank accounts, and the like.

The invention will be described initially with reference first to FIG. 1. As shown in FIG. 1, a biometric authentication system 100 includes a biometric security device 101 comprising a plurality of biometric sensors (e.g., fingerprint scanner 102, an iris scanner 104 and a facial scanner 106), operably connected to scan control and computer 107, which is connected to database 108. The biometric sensors, when activated, capture real time data corresponding to a stable physical characteristic of a person such as a fingerprint, palm print, full facial image, features of the iris of the eye or eye retinal pattern. It is to be appreciated that the biometric sensors 102, 104, 106, are merely exemplary and provided for sake of illustration. Other embodiments may include any well known sensor including, for example, hand geometry readers, DNA readers, dynamic signature readers, and other biometric sensors known in the art.

The following embodiments describe various methods directed to selectively activating biometric sensors to conserve system resources while performing biometric identification procedures.

Referring first to FIGS. 1 and 2, a first embodiment for selectively activating biometric sensors to conserve system resources while performing biometric identification procedures is shown in the form of a flowchart 200.

At act 202, a user or patron wishing to access a physical plant or real property or a service as well as resources such as computer data, bank accounts, and the like submits to a biometric scan to be performed by the biometric authentication system 100. In accordance with the principles of the invention, to conserve system resources, only the first tier biometric sensor, e.g., the fingerprint scanner 102, will be initially activated to perform the biometric scan of the user. All second tier sensors such as, iris scanner 104 and facial scanner 106 are initially deactivated (i.e., in a powered down state). As is conventional, the fingerprint scanner 102 will capture a real time stable fingerprint image directly from the user, encode the image, and compare the encoded image to stored physical characteristics in the database 108.

Act 204 is a determination act to determine whether the biometric of the user was verified by the first tier biometric sensor 102 at act 202.

At act 206, upon determining at act 204 that the user's biometric was unsuccessfully verified by the first tier biometric sensor 102 at act 202, the user is denied access and the process terminates at this point.

At act 208, upon determining at act 204 that the user's biometric was successfully verified by the first tier biometric sensor 102 at act 202, one or more of the second tier biometric sensors 104, 106 are activated to attempt to verify the biometric of the user, i.e., to verify the successful detection made by the first tier sensor as a result of acts 202 and 204.

Act 210 is a determination act to determine whether the biometric of the user was verified by at least one activated second tier biometric sensor 104, 106 at act 208.

At act 212, upon determining at act 210 that the user's biometric was verified by at least one second tier biometric sensor 104, 106, the user is granted access and the process terminates.

At act 214, upon determining at act 210 that the user's biometric was unsuccessfully verified by at least one second tier biometric sensor 104, 106, at act 210, the user is denied access and the process terminates.

In sum, in accordance with the principles of the first embodiment 200, a second tier sensor is only activated in response to the successful user verification by the first tier sensor. Otherwise, all second tier sensors remain in a quiescent (i.e., powered down) mode thereby conserving system resources in accordance with the principles of the invention.

Referring now to FIGS. 1 and 3, a second embodiment for selectively activating biometric sensors to conserve system resources while performing biometric identification procedures is shown in the form of a flowchart 300.

At act 302, a user or patron wishing to access a physical plant or real property or a service as well as resources such as computer data, bank accounts, and the like submits to a biometric scan to be performed by the biometric authentication system 100. In accordance with the principles of the invention, to conserve system resources, only the first tier biometric sensor, i.e., the fingerprint scanner 102, will be initially activated to perform the biometric scan of the user. All other second tier sensors, e.g., the, iris scanner 104 and facial scanner 106, are initially deactivated. As is conventional, the fingerprint scanner 102 will capture a real time stable fingerprint image directly from the user, encode the image, and compare the encoded image to stored physical characteristics in the database 108.

Act 304 is a determination act to determine whether the biometric of the user was verified by the first tier sensor 102 at act 302.

At act 306, upon determining at act 304 that the user's biometric was not verified by the first tier biometric sensor 102, one or more of the second tier sensors 104, 106 will be activated to verify the biometric of the user. The process then continues at act 310.

At act 308, upon determining at act 304 that the user's biometric was verified by the first tier biometric sensor 102 at act 302, the user is granted access and the process terminates.

Act 310 is a determination act to determine whether the biometric of the user was verified by at least one activated second tier biometric sensor 104, 106.

At act 312, upon determining at act 310 that the user's biometric was not verified by at least one second tier biometric sensor 104, 106, at act 310, the user is denied access and the process terminates.

At act 314, upon determining at act 310 that the user's biometric was verified by at least one second tier biometric sensor 104, 106, the user is granted access and the process terminates.

In sum, in accordance with the principles of the second embodiment 300, a second tier sensor 104, 106 is only activated in response to an unsuccessful verification of a user by the first tier sensor 102. Otherwise, all second tier sensors 104, 106 remain in a quiescent mode thereby conserving system resources in accordance with the principles of the invention.

Referring now to FIGS. 1 and 4, a third embodiment for selectively activating biometric sensors to conserve system resources while performing biometric identification procedures is shown in the form of a flowchart 400.

At act 402, a user or patron wishing to access a physical plant or real property or a service as well as resources such as computer data, bank accounts, and the like submits to a biometric scan to be performed by the biometric authentication system 100. In accordance with the principles of the invention, to conserve system resources, only the first tier biometric sensor, i.e., the fingerprint scanner 102, will be initially activated to perform the biometric scan of the user. All other second tier sensors, i.e., the, iris scanner 104 and facial scanner 106 are initially deactivated. As is conventional, the fingerprint scanner 102 will capture a real time stable fingerprint image directly from the user, encode the image, and compare the encoded image to stored physical characteristics in the database 108.

Act 404 is a determination act to determine whether the biometric of the user was verified by the first tier sensor 102 at act 402.

At act 406, upon determining that the user's biometric was not verified at act 404, the user is denied access and the process terminates.

Act 408 is a determination act, upon determining that the user's biometric was verified at act 404, act 408 determines whether the user desires a service exceeding a pre-determined service level threshold value TH₁. For example, a user may wish to conduct an ATM transaction involving a sum in excess of one million dollars (the threshold value).

At act 409, upon determining at act 408 that the user's desired level of service did not exceed the pre-determined threshold value TH₁, the user is granted access and the process terminates.

At act 410, upon determining at act 408 that the user desires a service level exceeding the pre-determined threshold value TH₁, at least one second tier biometric sensor, 104, 106 is activated to verify the biometric of the user.

Act 412 is a determination act to determine whether the biometric of the user was verified by at least one activated second tier biometric sensor 104, 106 at act 410.

At act 414, upon determining at act 412 that the user's biometric was verified by at least one second tier biometric sensor 104, 106, the user is granted access and the process terminates.

At act 416, upon determining at act 412 that the user's biometric was not verified by at least one second tier biometric sensor 104, 106, the user is denied access and the process terminates.

In sum, in accordance with the principles of the third embodiment 400, one or more second tier sensors are activated only in the case where two pre-conditions are satisfied. As a first condition, a first tier biometric sensor 102 must successfully verify the biometric of the user, and as a second condition, it must then be determined that the user desires a service level in excess of a pre-defined threshold level. If one or both pre-conditions are not satisfied, the one or more second tier sensors 104, 106 remain deactivated thereby conserving system resources in accordance with the principles of the invention.

Referring now to FIGS. 1 and 5, a fourth embodiment for selectively activating biometric sensors to conserve system resources while performing biometric identification procedures is shown in the form of a flowchart 500.

At act 502, a user or patron wishing to access a physical plant or real property or a service as well as resources such as computer data, bank accounts, and the like submits to a biometric scan to be performed by the biometric authentication system 100.

At act 503, an environmental parameter such as, for example, the air quality or equivalent ambient air temperature is measured.

Act 504 is a determination act to determine whether the measured environmental parameter (e.g., air quality or equivalent ambient air temperature) results in a reading outside of an expected range R (e.g., the air is determined to be either too humid or too dry). The process continues at act 510 for an unsuccessful determination at act 504.

At act 506, the first tier biometric scanner 102 is activated to attempt to verify the biometric of the user.

Act 508 is a determination act to determine whether the biometric of the user was successfully verified by the first tier sensor 102.

At act 509, upon determining at act 509 that the user was not successfully verified by the first tier sensor 102, the user is denied access and the process terminates.

Act 510 is a determination act to determine whether another measured environmental condition exceeds a pre-determined threshold value TH₂. For example, the ambient light may be measured to determine whether it exceeds a pre-determined luminosity in which case the facial detector sensor 104 would be turned on as a second tier biometric sensor.

At act 512, upon determining at act 510 that the environmental condition TH₂ exceeds the pre-determined threshold value TH₂, one or more second tier sensors 104, 106 are activated.

At act 514, upon determining at act 510 that the environmental condition TH₂ does not exceed the pre-determined threshold value TH₂, the user is denied or granted access based on the result of the first tier sensor 102 at act 508 or based on whether the first tier sensor 102 was activated. Thus, if at least one of the acts 506, 508 was bypassed, then the user is denied access in act 514. The process terminates at this point.

Act 516 is a determination act to determine whether the biometric of the user was successfully verified by at least one activated second tier biometric sensor 104, 106.

At act 518, upon determining at act 516 that the user's biometric was not successfully verified by at least one second tier biometric sensor 104, 106, the user is denied access. The process terminates at this point.

At act 520, upon determining at act 516 that the user's biometric was verified by at least one second tier biometric sensor 104, 106, the user is granted access. The process terminates at this point.

In sum, in accordance with the principles of the fourth embodiment 500, a first tier sensor 102 is activated only in the case where an environmental condition associated with the first tier sensor is satisfied. For example, if the ambient air is determined to be adequate (not to humid or dry) then the first tier sensor, e.g., fingerprint scanner is used to perform a biometric scan. Thereafter, is a determination act to determine whether an environmental condition associated with a second tier sensor is satisfied. If so, a further biometric scan is performed on the user using a second tier sensor. If the environmental condition associated with the second tier sensor is not satisfied then a user is either denied or granted access based solely on the outcome of the first tier sensor or whether it was bypassed.

Referring now to FIGS. 1 and 6, a fifth embodiment for selectively activating biometric sensors to conserve system resources while performing biometric identification procedures is shown in the form of a flowchart 600.

At act 602, during an enrollment phase, a user registers his or her biometric with the biometric system 100. Registration generally involves a user attempting to perform a biometric identification with the system using each of the first tier and second tier biometric sensors. The system 100 determines and records which biometric sensors produce a favorable outcome (a successful verification) for the user and which sensors produce an unfavorable result (an unsuccessful verification). This enrollment biometric information is then recorded in the system database 108 and assigned an access key number (i.e., personal identification number PIN) which is also stored on a magnetic storage medium of a token.

At act 604, a user, during an operational stage, presents his or her token to the security device 101 of the system 100 to initiate a biometric identification procedure to attempt to gain access to the system 100.

At act 606, the system retrieves the user's pre-stored biometric enrollment data to determine which sensors to turn on for the user. That is, only those sensors will be turned on which produced a favorable biometric result for the user during the enrollment phase.

All other sensors remain in their quiescent mode thereby conserving system resources in accordance with the principles of the invention.

At act 608, is a determination act to determine whether the biometric of the user was verified by those activated sensors which produced a favorable result for the user during enrollment.

At act 610, upon determining at act 608 that the user's biometric was not verified, the user is denied access. The process terminates at this point.

At act 612, upon determining at act 608 that the user's biometric was verified, the user is granted access. The process terminates at this point.

In sum, it is shown in the present embodiment 600 that the biometric identification system 100 has been customized to each user's particular biometric detection characteristics, during enrollment, and is therefore more likely to produce a favorable outcome during an operational stage and negate the necessity of turning on those sensors which are likely to produce an unfavorable result. In this manner system resources are conserved in accordance with the principles of the invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A method for selectively activating biometric sensors (102, 104, 106) to authenticate the identity of an individual while conserving system resources, comprising the acts of:
activating a first tier biometric sensor (102) to verify the biometric of said individual; and
activating a second tier biometric sensor (104, 106) to verify the biometric of said individual in the case where said individual is successfully verified with said first tier biometric sensor (102).

2. The method of claim 1, wherein said second tier biometric sensor (104, 106) is a comparatively more sophisticated sensor than said first tier biometric sensor (102).

3. A method for selectively activating biometric sensors (102, 104, 106) to authenticate the identity of an individual while conserving system resources, comprising the acts of:
activating a first tier biometric sensor (102) to verify the biometric of said individual; and
activating a second tier biometric sensor (104, 106) to verify the biometric of said individual in the case where said individual is unsuccessfully verified with said first tier biometric sensor (102).

4. The method of claim 3, wherein said second tier biometric sensor (104, 106) is a comparatively more sophisticated sensor than said first tier biometric sensor (102).

5. A method for selectively activating biometric sensors (102, 104, 106) to authenticate the identity of an individual while conserving system resources, comprising the acts of:
activating a first tier biometric sensor (102) to verify the biometric of said individual;
determining whether said individual desires a service level exceeding a predetermined service level threshold; and
activating a second tier biometric sensor (104, 106) to verify the biometric of said individual when it determined that said individual desires said service level exceeding said threshold.

6. The method of claim 5, wherein said second tier biometric sensor (104, 106) is a comparatively more sophisticated sensor than said first tier biometric sensor (102).

7. A method for selectively activating biometric sensors (102, 104, 106) to authenticate the identity of an individual while conserving system resources, comprising the acts of:
activating a first tier biometric sensor (102) to verify the biometric of said individual;
determining whether an environmental parameter is outside of a predetermined range; and
activating a second tier biometric sensor (104, 106) to verify the biometric of said individual when said environmental parameter is determined to be outside said predetermined range.

8. The method of claim 7, wherein said second tier biometric sensor (104, 106) is a comparatively more sophisticated biometric sensor than said first tier biometric sensor (102).

9. A method for selectively activating biometric sensors (102, 104, 106) to authenticate the identity of an individual while conserving system resources, comprising the acts of:
during an enrollment stage, enrolling said individual with a biometric system using first tier (102) and second tier biometric sensors (104, 106);
determining which first (102) and second tier biometric sensors (104, 106) result in a successful biometric verification of said individual thereby yielding enrollment biometric data for said individual;
storing the enrollment biometric data and a personal identification number (PIN) for said individual on a magnetic storage medium of a token;
during an operational stage, verifying the biometric of said individual comprising the acts of:
verifying the PIN stored on said individual's token;
using the enrollment biometric data stored on said token to activate only those first (102) and second tier biometric sensors (104, 106) which have been previously determined to result in said successful biometric verification of said individual during said enrollment stage; and
attempting to verify the biometric of said individual using only the activated biometric sensors.

10. The method of claim 9, wherein the token comprises a magnetic stripe having multiple tracks for storing the biometric enrollment data and PIN.

11. The method according to claim 9, wherein the token comprises at least one of an access card, credit card, debit card, identification card and smart card.

12. The method according to claim 9, wherein verifying the PIN comprises: reading the PIN from the magnetic storage medium; requesting a verification PIN from said individual; and comparing the PIN read from the magnetic storage medium with the verification PIN.

13. A system (100) for selectively activating biometric sensors (102, 104, 106) to authenticate the identity of an individual while conserving system resources, the system comprising:
a biometric security device (101) comprising a plurality of biometric devices;
at least one processor (107) connected to said biometric security device (101), said at least one processor (107) including one or more databases (108) for storing biometric and user data;
said processor (107) programmed to:
activate a first tier biometric sensor (102) to verify the biometric of said individual; and
activate a second tier biometric sensor (104, 106) to verify the biometric of said individual in the case where said individual is successfully verified with said first tier biometric sensor (102).

14. The system (100) of claim 13, wherein said second tier biometric sensor (104, 106) is a comparatively more sophisticated sensor than said first tier biometric sensor (102).

15. A system (100) for selectively activating biometric sensors (102, 104, 106) to authenticate the identity of an individual while conserving system resources, the system (100) comprising:
a biometric security device (101) comprising a plurality of biometric devices;
at least one processor (107) connected to said biometric security device (101), said at least one processor (107) including one or more databases (108) for storing biometric and user data;
said processor (107) programmed to:
activate a first tier biometric sensor (102) to verify the biometric of said individual; and
activate a second tier biometric sensor (104, 106) to verify the biometric of said individual in the case where said individual is unsuccessfully verified with said first tier biometric sensor (102).

16. The system (100) of claim 15, wherein said second tier biometric sensor (104, 106) is a comparatively more sophisticated sensor than said first tier biometric sensor (102).

17. A system (100) for selectively activating biometric sensors (102, 104, 106) to authenticate the identity of an individual while conserving system resources, the system (100) comprising:
a biometric security device (101) comprising a plurality of biometric devices;
at least one processor (107) connected to said biometric security device (101), said at least one processor (107) including one or more databases (108) for storing biometric and user data;
said processor (107) programmed to:
activate a first tier biometric sensor (102) to verify the biometric of said individual;
determining whether said individual desires a service level exceeding a predetermined service level threshold; and
activate a second tier biometric sensor (104, 106) to verify the biometric of said individual when it determined that said individual desires said service level exceeding said threshold.

18. The system (100) of claim 17, wherein said second tier biometric sensor (104, 106) is a comparatively more sophisticated sensor than said first tier biometric sensor.

19. A system (100) for selectively activating biometric sensors (102, 104, 106) to authenticate the identity of an individual while conserving system resources, the system (100) comprising:
a biometric security device (101) comprising a plurality of biometric devices;
at least one processor (107) connected to said biometric security device (101), said at least one processor (107) including one or more databases (108) for storing biometric and user data;
said processor (107) programmed to:
activate a first tier biometric sensor (102) to verify the biometric of said individual;
determining whether an environmental parameter is outside of a predetermined range; and
activate a second tier biometric sensor (104, 106) to verify the biometric of said individual when said environmental parameter is determined to be outside said predetermined range.

20. The system (100) of claim 19, wherein said second tier biometric sensor (104, 106) is a comparatively more sophisticated sensor than said first tier biometric sensor (102).

21. A system (100) for selectively activating biometric sensors (102, 104, 106) to authenticate the identity of an individual while conserving system resources, the system (100) comprising:
a biometric security device (101) comprising a plurality of biometric devices;
at least one processor (107) connected to said biometric security device (101), said at least one processor (107) including one or more databases (108) for storing biometric and user data;
said processor (107) programmed to:
during an enrollment stage, enrolling said individual with a biometric system using first tier (102) and second tier biometric sensors (104, 106);
determining which first (102) and second tier (104, 106) biometric sensors result in a successful biometric verification of said individual thereby yielding enrollment biometric data for said individual;
storing the enrollment biometric data and a personal identification number (PIN) for said individual on a magnetic storage medium of a token;
during an operational stage, verifying the biometric of said individual comprising the acts of:
verifying the PIN stored on said individual's token;
using the enrollment biometric data stored on said token to activate only those first (102) and second tier biometric sensors (104, 106) which have been previously determined to result in said successful biometric verification of said individual during said enrollment stage; and
attempting to verify the biometric of said individual using only the activated biometric sensors.

22. The system (100) of claim 21, wherein said second tier biometric sensor (104, 106) is a comparatively more sophisticated sensor than said first tier biometric sensor (102).
